(19) United States
(12) Patent Application Publication
(10) Pub. No.: US 2022/0176727 A1
(43) Pub. Date: Jun. 9, 2022

(54) Tag System to Mitigate Maliciously Tainted and Counterfeit Products

(71) Applicant: Lexmark International, Inc., Lexington, KY (US)

(72) Inventors: JAMES HOWARD ELLIS, LEXINGTON, KY (US); KEITH BRYAN HARDIN, LEXINGTON, KY (US); ROBERT HENRY MUYSKENS, LEXINGTON, KY (US); MITCHELL RAY ROWLETTE, BEREA, KY (US); CARL EDMOND SULLIVAN, STAMPING GROUND, KY (US)

(21) Appl. No.: 17/542,406

(22) Filed: Dec. 4, 2021

Related U.S. Application Data
(60) Provisional application No. 63/121,568, filed on Dec. 4, 2020.

(51) Int. Cl. B42D 25/369; G09F 3/00; B41M 7/00; B41M 3/14

(52) U.S. Cl. CPC B42D 25/369; B41M 3/14; B41M 7/0045; G09F 3/0292

(57) ABSTRACT

In the invention described, a method of creating a unique tag or labeling system for electronic printed circuit board assemblies (PCBA) that is unique, virtually un-duplicatable, and may be altered when the electronics are tampered with.

### CROSS REFERENCES TO RELATED APPLICATIONS

This application claims priority and benefit under 35 U.S.C. 119(e) from U.S. provisional application No. 63/121,568 titled “Tag System to Mitigate Maliciously Tainted and Counterfeit Products,” having a filing date of Dec. 4, 2020.

### BACKGROUND

### 1. Field of the Invention

This invention relates generally to ways to alleviate and combat counterfeit or tainted parts.

### 2. Description of the Related Art

Typical existing labels have disadvantages of being counterfeited by copied manufacturing processes. Materials, processes and manufacturing processes are needed to improve the security of product components.

Counterfeit and maliciously tainted devices are prevalent in the electronics industry. These fake devices create a huge financial and security concern in technology products. The risks can be as simple as warranty claims for a failed counterfeit device/system, or can be as subtle as a device that is siphoning secure data from the network and re-broadcasting the information to a nefarious source. Various methods have been attempted to alleviate and combat these counterfeited or tainted parts. Most center around the use of a label or marking that is difficult to reproduce. Yet these solutions are not very secure since they rely on the uniqueness and control of the label/marking. Simple labels like bar codes and multi-layer labels are in general easy to reproduce or remove from an existing product. Once tainted or counterfeit devices are in the supply chain, it can be devastating to customers and the Original Equipment Manufacturer (OEM).

### SUMMARY OF THE INVENTION

Disclosed is an invention that provides a method of creating a unique tag or labeling system for electronic printed circuit board assemblies (PCBA) that is unique, virtually un-duplicatable, and may be altered when the electronics are tampered with. The main embodiment of this invention employs the attachment of previously randomized magnetized particles in an adhesive material that is in turn attached to the PCBA. The particles may be randomly sized and shaped. Since the particle placement, the magnetic field direction and the magnetic field strength of the particles are random, the magnetic field produced by the material attached to the adhesive is unique and virtually impossible to reproduce. For brevity, this will be called UMT (unique magnetic tag). Thus by reading the magnetic image of the UMT, a unique image is recorded. This UMT is then recorded along with the PCBA serial number (this is typically a standard bar code) to a secure cloud location. This unique pairing now identifies the device at the time of manufacture.

### BRIEF DESCRIPTION OF THE DRAWINGS

Having thus described the invention in general terms, reference will now be made to the accompanying drawings, which are not necessarily drawn to scale, and wherein:

FIG. 1 shows a system of attachments such as bar code labels to a unique magnetic tag.

FIG. 2 shows a block diagram of a method for reading and storing a unique magnetic tag in the cloud.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology, terminology and dimensions used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art. The dimensions of the magnetic particles, separations between particles and sensor locations are interrelated and can be proportionally scaled with respect to each other to provide different sized solutions.

The present invention is described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

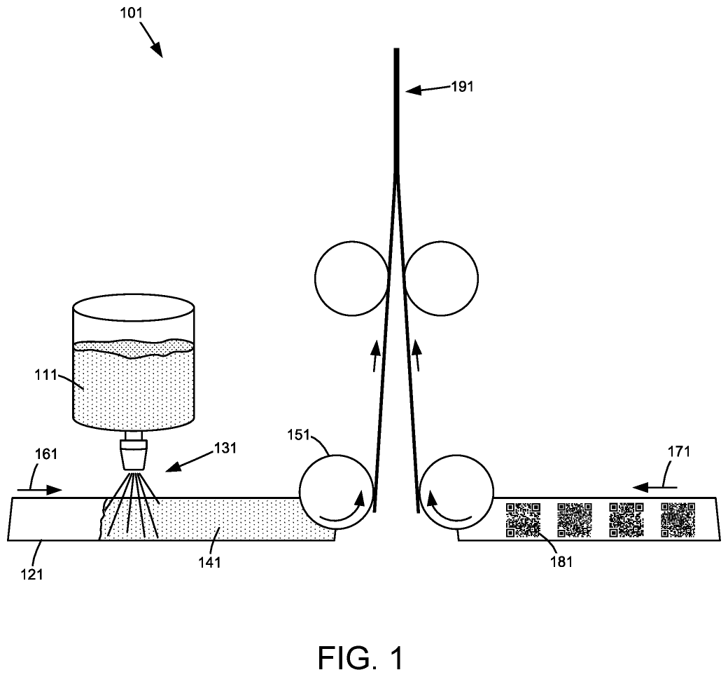

This invention describes a method of creating a unique tag or labeling system for electronic printed circuit board assemblies (PCBA) that is unique, virtually un-duplicatable, and may be altered when the electronics show tampering. The main embodiment of this invention employs the attachment of previously randomized magnetized particles in an adhesive material that is in turn attached to the PCBA. Since the particle placement, the magnetic field orientation and the magnetic field strength of the particles are random, the magnetic field produced by the material attached to the adhesive is unique and virtually impossible to reproduce. The tag has a two-dimensional (2D) surface area that can be brought in contact with a magnetic field sensor or array of sensors. The sensor measures a predetermined area of the tag. This surface magnetic field varies dramatically over the area and can be represented as an intensity for each location resulting in an image, picture, or fingerprint. This intensity can be an amplitude or magnitude of the magnetic field value for any orthogonal direction or combinations of directions. It can also represent the angles from a reference direction. For brevity, this will be called UMT (unique magnetic tag). Thus by reading the magnetic image of the UMT, a unique image is recorded. This UMT is then recorded along with the PCBA serial number, typically a standard bar or quick response (QR) code, to a secure cloud location. This enrollment process creates a unique pairing of the UMT magnetic image and PCBA serial number, where the pairing may use any combination of unencrypted, encrypted, hashed, or digitally signed data with a secret key, and now uniquely identifies the device at the time of manufacture. Once paired, the UMT object has a functionality known as a cryptoanchor (CA). A CA is any object that can be identified with a digital representation that is very unique and difficult to copy. Such a system is shown in FIG. 1 of the attachments where bar code labels are attached to UMT material. The terms UTM or CA can be used interchangeably depending on context. Generally, UMT referred to the material before it is enrolled and CA is the combination of UMT with the enrollment information.

In FIG. 1, an adhesive tape 121 is shown, for example, traveling in a direction 161 under a reservoir of randomized magnetic particles 111 that are applied 131 to the surface of the adhesive tape 121 yielding a tape with a random distribution of magnetic particles 141. Any suitable manufacturing method may be used to apply the UMT material. This includes molding, extrusion, forming (hot or cold), or inkjetting. Separately, a tape or film with barcodes 181 is traveling in direction 171 toward the adhesive tape 141. Rollers, 151, for example, or other suitable material handling equipment align the tape and bar code film to join 191 and form a combined barcode and UMT.

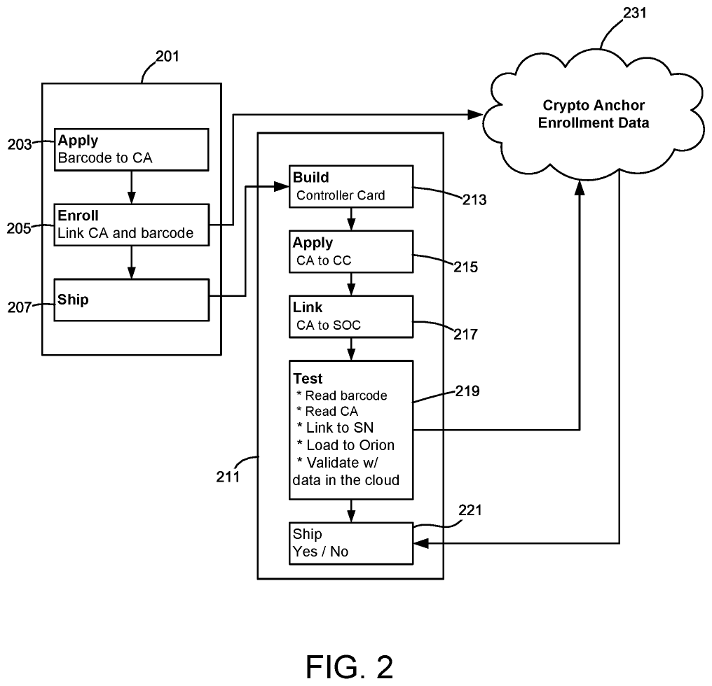

FIG. 2 shows a block diagram of one possible enrollment method for reading and storing the data associated with the UMT in the cloud. A CA enrollment facility 201 is a secure location that analyzes the UMT images to keep the encryption methods a secrete. A raw printed circuit board (PCB) is sent to an assembly factory where the CA and additional components are added to make a PCBA. An example use of a PCBA is for electronic devices called controller cards. These cards have functionality that control processes within a device. The current invention is applicable to a much wider range of functionality than a controller card. This use of controller card is representative of any PCBA functionality. At a CA enrollment facility 201, a barcode is applied to a CA 203, the CA is enrolled 205, as previously described, thus linking the CA to the barcode, storing the information in the cloud 231, and the CA is shipped 207 to a controller card factory 211. At the controller card factory 211, a controller card is built 213, and a CA is applied to the controller card 215. The is then linked 217 to the system on chip (SOC) on the controller card using any method of linkage such as storing data associated with the CA in the SOC electronic fuses or storing data associated with the CA and data associated with the SOC in a NVM on the controller card or in the cloud, where the data may be any combination of unencrypted, encrypted, hashed or digitally signed data with a secret key. The link between the CA and the system on chip is then tested 219 by a series of operations including: reading the barcode; reading the CA; linking the barcode and CA to the serial number (SN); loading the information to a data platform, such as ORION®, or other suitable platform; validating the barcode and CA information with data stored in the cloud 231; and shipping the controller card 221.

Verification of the device's authenticity requires reading the serial number, for example, the bar code, and the UMT magnetic image. These are then verified to match the equivalent data recorded in the secure cloud location during enrollment, using any suitable verification algorithm. Further verification of authenticity may be used to verify the link between the SOC and the CA using any suitable verification algorithm based on the format of the data used to establish the link. Since the magnetic image of the UMT is unique it would be difficult to counterfeit the tag/PCBA. Thus, the invention addresses the problem of counterfeit electronic assemblies (PCBA).

In addition to the process shown in FIG. 2, several other options are possible including: moving the enrollment of the UMT data for each device to the PCBA facility; or eliminating the step in which the UMT (or CA in FIG. 1) is linked to the SOC.

The second portion of this invention is more subtle but just as important. Another issue occurs when an authentic device is tampered with for malicious reasons. An example of one of these is the replacement of an Ethernet PHY/physical interface with a substitute device that records and broadcasts data to a non-intended recipient. To combat this tampering, the UMT uses a property of the magnetic material or the adhesive it is constructed with. In the first method, the magnetic particles which are applied to the adhesive in the UMT are known to change when the particles are heated. This is due to the reduction of the magnetic field strength of each particle. To modify the PCBA, devices must be removed and new devices attached using a soldering technique, this produces relatively high temperatures (>280 C). This high temperature produces a change in the magnetic field strength that permanently alters the magnetic image of the UMT such that it will not match the UMT and serial number stored in the secure cloud location. Therefore, tampering with the device would be detected and the device would be labeled as counterfeit. Another possible method includes the properties of the adhesive on the UMT. The adhesive can be developed that hardens at an elevated temperature causing the tag to no longer adhere to the PCB. In addition, the same process can be applied to the adhesive material in which the magnetic particles are embedded. By choosing a certain class of materials one can make that material either more or less susceptible to temperature. In the case of susceptibility to temperature, as the material heats up the magnetized particles will move within the material. This movement would likewise result in the alteration of the magnetic image of the UMT. Different polymer materials could be chosen which would deform at a desired trigger temperature which would indicate tamper, a simple example of this would be a heat shrink film.

Again, when verified against the secure cloud data, the tampered device would be classified as a counterfeit.

In a further embodiment of the invention, the UMT is attached to the PCBA (either intrinsically in the board layers or extrinsically via an adhesive) in close spatial proximity to a magnetic field sensor (such as a hall effect device) assembled on the PCBA in order to shield the UMT and restrict physical access as well as to electronically read the magnetic field of the UMT when required. This can be accomplished by soldering magnetic field sensor over the top of the UMT. If the UMT is sensitive to the soldering process, a sensor that has an open cavity between the PCBA and sensor can have the UMT inserted after the soldering process. An adhesive can then be injected to hold the UMT in place. Also assembled onto the PCBA is a System-on-Chip (SOC) and non-volatile memory (NVM) that will be used to read and store the CA data from the enrollment process at the factory during manufacturing and provide the data for and execute the verification process in the field during operation.

Enrollment at the factory during manufacturing begins with the PCBA serial number read from the barcode attached to the PCBA and the barcode's digital value is stored in secure electronic fuses in the SOC device. The SOC then records the UMT's magnetic field fingerprint by reading the digital value from the magnetic field sensor that has been assembled in close spatial proximity to the UMT on the PCBA. The PCBA serial number and UMT magnetic field digital values are then combined, signed, encrypted and stored in the non-volatile memory using state of the art hashing, encryption and digital signature methods such as SHA, AES, RSA, DSA and/or ECDSA and a private manufacturer's key that is physically secured in the PCBA manufacturing facility.

Verification in the field during system operation is initiated automatically by the SOC at periodic intervals or by remote command by an external network monitoring system.

Verification begins with the SOC recording the UMT's magnetic field fingerprint by reading the digital value from the magnetic field sensor that has been assembled in close spatial proximity to the UMT on the PCBA. The SOC then proceeds to read, verify, and decrypt the enrolled data from the non-volatile memory (NVM) using the analogous verification and decryption algorithms used at time of enrollment (such as SHA, AES, RSA, DSA, and/or ECDSA) and a public manufacturer's key stored in the SOC's firmware or in the SOC's electronic fuses.

After the NVM enrollment data integrity has been verified and decrypted, the SOC will separate the decrypted data into the original parts of PCBA serial number data and UMT magnetic field data. The SOC will then verify that the PCBA serial number retrieved from the non-volatile memory matches the PCBA serial number stored in the SOC's electronic fuses. Next, the SOC will verify that the UMT magnetic field data retrieved from the non-volatile memory (stored during enrollment) matches the UMT magnetic field sensor just read live during system operation. If either the PCBA serial number or UMT magnetic field verification test fail to match, then a PCBA tamper event is triggered.

The system will continue to function normally until a tamper event is detected. When a tamper event is detected an intervention process is initiated. An intervention process could consist of any number of the following actions: (1) reset and restart the system; (2) shut the system down temporarily (for a duration of time); (3) shut the system down permanently (such as by programming a fuse in the SOC); and/or (4) notify an external monitoring system through a network connection.

In a further embodiment of the invention, multiple UMT's and associated magnetic field sensors could be assembled onto the PCBA with each individual UMT and associated sensor pair being dispersed spatially from the others to provide a large area of coverage of the PCBA. Further, the magnetic field data from each individual UMT and sensor pair could be combined during the enrollment process and later used during the verification process to provide greater security and protection against tampering in a region on the PCBA that is isolated from the location of a UMT and magnetic field sensor pair.

During enrollment, the SOC would read the magnetic field data from each UMT and associated magnetic field sensor pair. The SOC would combine PCBA serial number with the magnetic field data of each UMT with a state-of-the-art hashing, encryption, and digital signing process as previously described. This securely links all UMT together so that altering any one UMT will cause the verification process to fail and a tamper detection event to be initiated.

During verification, the SOC would read the magnetic field data from each UMT and associated magnetic field sensor pair. The SOC would then read the enrollment data from the NVM and verify, decrypt and separate individual data fields as previously described. The SOC verifies the PCBA serial number and magnetic field data of each UMT as previously described. If any verification test fails then a tamper event is detected, and an intervention process is initiated.

As a result of one or more UMT and associated magnetic field sensor pairs assembled onto the PCBA during manufacturing with enrollment of one or more UMT unique identifiers in NVM along with the PCBA serial number, it is possible to reduce or eliminate the tampering of PCBA systems anywhere in the supply chain including the operation in the field by an adversary who desires to alter or take over an electronic system for nefarious purposes. All previously described variants of the UMT itself can be combined with this aspect of the invention to provide an automatic, self-initiated, continuous monitoring and reporting mechanism to ensure the integrity of the PCBA system over its operational life.

Current methods of “tamper” resistance utilize what is called “tamper tape” in the industry. This tape when removed leaves a written message such as “void” (referring to the warranty) or “do not use” (to warn customer/installer that the device has been altered. These methods help but are not sufficient since the “written” message can be removed/cleaned and a new “fresh label” applied. If the UMT is tampered with, the temperatures that the UMT is exposed to permanently alter the magnetic image of the UMT and the data will never verify against the data protected in the secure cloud storage.

Unique tag systems exist today. Most involve the use of multi-layer or holographic image (like used on credit cards or special identifier labels with trademarks. These are more difficult to produce but evidence exists in great amounts that these types of tags/labels have been easily defeated. The UMT on the other hand has great advantage over these. First, it is invisible to a person without a magnetic imaging device. Second, since the image is not “produced” but the result of the random location, orientation, and magnetic field strength of the particles; the reproduction of the image is a very remote possibility (1 in 10,000,000,000).

The premagnetized magnetic particles can also be injected into the resin during PCB manufacturing to make a preferred stripe area at the edges of the PCB. This resin can be part of the resin and fiberglass layer or in the prepreg area between two layers. It would not be generally distributed throughout the PCB due to the possible interaction between the current flowing within the other electronics. This injection of the magnetized magnetic particle resin can be injected into a drill hole or recessed area of the PCB. This way the materials may be added during any part of the manufacturing process. If it was added after the PCB has been assembled, then resin could be temperature reactive that could allow rearrangement of the magnetic particles or change color or texture.

In the case of a post application in the drill hole the applied material could be allowed on the surface with a larger area than the hole and flow through the hole and be larger than the hole on the back side. This creates a geometry like a PUF rivet in the PCB. Tampering the rivet would affect the magnetic response.

The premagnetized resin or glue may be screened on to any layer void in the PCB. For example, any layer may have a predetermined area punched out of the PCB. This layer is then stacked on any other layer with a prepreg material to glue the two layers together.

The premagnetized resin may then be screened onto the surface filling the punched area. This will constrain the magnetic particles to the punched area. If this is an exterior layer the PCB can be pressed and cured. If an interior layer, then other layers are stacked and bonded. In the case that the UMT is a tag attached to the board at manufacturing. The tag could be made to be tamper evident, in that a proper choice of a polymer for the tag could be selected that would bind with the adhesive material such that the tag is destroyed if removed. Examples of this would be an epoxy UMT with epoxy adhesive. Thin flexible/deformable UMT film with a very strong adhesive.

In the case that the UMT is a tag attached to the PCB board in manufacturing. The tag could be placed on top of a small but integral set of board components. The tag could be bonded to the board with a bonding agent which fully encapsulates these integral components while also attaching the tag. In this embodiment, the removal of the tag would leave visible bonded adhesive and attempts to grind or otherwise remove the adhesive would remove or damage the components which are either integral to the function of the board or activate a signal that indicates tamper to the board.

In the case that magnetic particles are dispersed directly in a bonding agent such as but not limited to epoxy. This bonding agent with particles could be dispensed over an integral component of the board. Upon attempt to remove the bonding agent, the component would be damaged, or bonding agent would remain that indicates tamper. Dispensing methods such as FDM, liquid dispense, resin transfer, casting, etc., could be included.

The inclusion of multiple UMT and/or magnetic field sensor pairs that are distributed uniformly spatially across the entire surface area of the PCBA prevents localized tampering of the PCBA in an area separate from the UMT and/or associated magnetic sensor.

The active monitoring system provided by the inclusion of one or more magnetic field sensor and UMT pairs would enable the integrity of the PCBA to be verified anywhere in the supply chain including in the field over entire operational life either automatically or on demand from an external monitoring system.

The intrinsic, automatic self-monitoring provided by this system enables protection against tampering when the PCBA is disconnected from a network connection. This provides a means to verify the integrity of the system automatically when the system is operating and to initiate an intervention automatically without an operator or an external network monitoring system. The intervention could range from any number of actions including permanent disablement of the system.

The extrinsic, on demand monitoring provided by this system enables a remote monitoring and data collection system to periodically test the integrity of the system as part of assessing health of the system. The number of tamper events could be recorded and provided to a network monitor to send a technician to proactively service the system.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

We claim:

1. A method of making a unique magnetic tag consisting of:
attaching previously randomized magnetized particles in an adhesive material; and
attaching the adhesive material to a printed circuit board assembly (PCBA);
wherein since the particle placement, the magnetic field direction and the magnetic field strength of the particles are random, the magnetic field produced by the material attached to the adhesive is unique and virtually impossible to reproduce.

2. The method of claim 1, further wherein the magnetic particles are applied directly to the back of a serial number/bar code identifier.

3. The method of claim 1, further wherein the unique magnetic tag is applied to a printed circuit board using a screen-printing process that would include mixing the solder mask used on the surface of the PCB or being mixed in the silkscreen on the PCB.

4. A unique magnetic tag embedded on an inner layer of a printed circuit board.

5. The method of claim 1, further wherein the magnetic particles are printed on the surface of a printed circuit board using an inkjet method.

6. The unique magnetic tag of claim 4, further wherein the unique magnetic tag is covered with a tamper resistant material such as epoxy, rendering removal next to impossible without damage.

7. The method of claim 1, further wherein a second screen printing process is employed to apply the unique magnetic tag to specific areas of the printed circuit board that are deemed as vulnerable to malicious attack.

8. A method of intentionally placing the magnetic particles within the solder of a printed circuit board consisting of:
selecting a solder with a melt temperature sufficiently below the curie point of the magnetic particles that are used; and
using the low melt temperature solder alloys to attach an integrated circuit or other electrical part to the printed circuit board; wherein an attempt to remove and replace an integrated circuit with a counterfeit the solder would inevitably be melted and cause the magnetic particles within the solder joints to move.

9. The unique magnetic tag of claim 4, further wherein the unique magnetic tag is physically shielded with a magnetic field sensor restricting physical access and providing an integrated verification system.

10. A system wherein one or more unique magnetic tags are distributed over the surface area of a printed circuit board assembly to reduce or eliminate printed circuit board assembly tampering.

11. A tamper resistant system that cryptographically links the magnetic field data of one or more unique magnetic tag's with a printed circuit board assembly serial number to provide an in-system tamper monitoring, detection, intervention and reporting system.

12. The system of claim 11, wherein a printed circuit board assembly serial number that is stored in a system-on-chip electronic device used for the purpose of tamper detection and verification.

13. The system of claim 11, wherein a non-volatile memory is used to store the cryptographically linked magnetic field data of one or more unique magnetic tag's and the printed circuit board assembly's serial number that is used for tamper detection, intervention, and reporting without the need for a network connection.

14. The system of claim 11, wherein a network connected off board storage system is used to store the cryptographically linked magnetic field data of one or more unique magnetic tag's and the printed circuit board assembly serial number that is used for tamper detection, intervention, and reporting.

15. The system of claim 11, wherein the system operates over the entire lifecycle of the printed circuit board assembly from all points from the original manufacturing to in-field operation to decommissioning.
